(19) United States
(12) Patent Application Publication
(10) Pub. No.: US 2011/0213771 A1
(43) Pub. Date: Sep. 1, 2011

(54) HYBRID SEARCH SYSTEM, HYBRID SEARCH METHOD, AND HYBRID SEARCH PROGRAM

(76) Inventor: Kyota Kanno, Tokyo (JP)

(21) Appl. No.: 13/128,340

(22) PCT Filed: Oct. 13, 2009
(86) PCT No.: PCT/JP2009/005322

§ 371 Date: May 9, 2011

(30) Foreign Application Priority Data
Nov. 18, 2008 (JP) 2008-294919

(51) Int. Cl. G06F 17/30

(52) U.S. Cl. 707/723; 707/769; 707/E17.014

(57) ABSTRACT

When a plurality of information search means are combined to search for information, a hybrid search system dynamically switches between combinations of information search means and ways of collecting search results from the plurality of information search means. In other words, the hybrid search system includes: a configuration management unit 100 for storing configuration information specifying the plurality of information search means in a configuration storage unit 300; and a search execution unit 200 causes each of the information search means 401₁ to 401ₙ, specified in the configuration information stored in the configuration storage unit 300, to execute an information search according to a search request.

### TECHNICAL FIELD

The present invention relates to a hybrid search system, a hybrid search method, and a hybrid search program, in which multiple information search means are combined to search for information.

### BACKGROUND ART

There is an information search system searching for information desired by a user, such as documents, images, video, and sound, from information groups stored in a database or information groups accessible through the Internet. When receiving an reformation search request including a keyword or the like from a user, the information search system searches for the information desired by the user from targeted information groups according to a predetermined search algorithm.

As the information search system, there are not only an information search system using a single search engine but also an information search system using multiple search engines (for example, see Patent Literatures 1, 2, and 3).

Patent Literature 1 discloses a hybrid search system (meta search system) for transmitting, to multiple search engines, a keyword or the like received from a user and combining the results to provide it to the user. In the hybrid search system, when a query is entered by the user into a Web page search engine, the Web page search engine transmits the entered query to many search engines. Each of the search engines produces a response corresponding to the received query and transmits the response to the Web page search engine. The Web page search engine analyzes the response received from each search engine and detects information on documents including the query entered by the user. Then, the documents indicating the detected information is downloaded and text surrounding the query entered by the user is extracted from the documents.

In a search system disclosed in Patent Literature 2, when search instructions are entered by a user, a search engine is selected from multiple search engines as being considered to output appropriate search results, and the search instructions are transmitted to the selected search engine to cause it to execute a search process.

In a hybrid search system disclosed in Patent Literature 3, when a query is entered by a user into a meta search engine, the meta search engine transmits the query entered by the user to multiple search engines to cause the multiple search engines to execute search processes.

### CITATION LIST

### Patent Literature

PTL 1: Japanese Patent Application Publication No. 11-191114 (Paragraphs 0012 to 0013)

PTL 2: Japanese Patent Application Publication No. 2006-1613842 (Paragraphs 0077 to 0084)

PTL 3: Published Japanese Translation of PCT International Application Publication No. JP-T-2006-528383 (Paragraphs 0033 to 0035)

### SUMMARY OF INVENTION

### Technical Problem

In each of the above-mentioned hybrid search systems, multiple search engines are used, but combinations of search engines are not dynamically changed upon execution of search processes. Patent Literature 2 teaches that a search engine to be caused to actually execute a search process is selected from multiple search engines at the start of the search process, but it does not means that the search system disclosed in Patent Literature 2 changes search engines upon execution of the search process.

Each of the above-mentioned hybrid search systems does not allow for changing ways to combine the multiple search engines.

Further, each of the above-mentioned hybrid search systems does not dynamically change modes of collecting the search results from the multiple search engines.

When the situation of a user or an environment surrounding the user has changed, the combination of search engines may need changing to obtain search results more relevant to the user. As an example, if it is known that the user is keenly interested in a specific field during an immediate, predetermined period, it will be preferred to give higher priority to the search results on the specific field than the search results on the other fields. If the combination of search engines is changed according to the situation of the user or the Like, the hybrid search system may be able to obtain search results more relevant to the user. However, each of the above-mentioned hybrid search systems cannot make a change to obtain search results more relevant to the user.

Further, when the situation of the user or the environment surrounding the user has changed during execution of a search process, the combination of search engines may need changing to obtain search results more relevant to the user. As an example, when a search request is made from a mobile terminal owned by the user to a hybrid search system while the user is moving, if the combination of search engines is changed along with the movement of the user, the hybrid search system may be able to obtain search results more relevant to the user. However, each of the above-mentioned hybrid search system cannot make a change to obtain search results relevant to the user.

Further, when the situation of the user or the environment surrounding the user has changed, if the mode of collecting the search results from the multiple search engines is changed, it may be able to provide search results more relevant to the user. As mentioned above, if it is known that the user is keenly interested in a specific field during an immediate, predetermined period, it will be preferred to provide the search results on the specific field by giving higher priority to the search results than the search results on the other fields. If the mode of collecting the search results from the multiple search engines is changed, the hybrid search system may be able to provide the user with search results more relevant to the user. However, each of the above-mentioned hybrid search systems cannot change the mode of collecting search results to provide search results more relevant to the user.

Further, when the situation of the user or the environment surrounding the user has changed during execution of a search process, the mode of collecting the search results from the multiple search engines may need changing to provide search results more relevant to the user. As an example, when a search request is made from a mobile terminal owned by the user to a hybrid search system while the user is moving, if the mode of collecting search results is changed along with the movement of the user, the hybrid search system may be able to provide search results more relevant to the user. However, each of the above-mentioned hybrid search system cannot change the mode of collecting the search results to provide search results more relevant to the user.

Therefore, it is an object of the present invention to provide a hybrid search system, a hybrid search method, and a hybrid search program, which can dynamically switch between combinations of information search means and ways of collecting search results from a plurality of information search means when the plurality of information search means are combined to search for information.

### Solution to Problem

A hybrid search system according to the present invention is a hybrid search system for combining a plurality of information search means to search for information, characterized by comprising: a configuration management unit for storing configuration information specifying the plurality of information search means in a configuration storage unit; and a search execution unit for causing each information search means, specified in the configuration information stored in the configuration storage unit, to execute an information, when a search request is received.

A hybrid search method according to the present invention is a hybrid search method for combining a plurality of information search means to search for information, characterized by comprising: storing configuration information specifying the plurality of information search means in a configuration storage unit; and causing each information search means, specified in the configuration information stored in the configuration storage unit, to execute an information search, when a search request is received.

A hybrid search program according to the present invention is a hybrid search program characterized by causing a computer in a hybrid search system, in which a plurality of information search means are combined to search for information, to execute: a process to store configuration information specifying the plurality of information search means in a configuration storage unit; and a process to cause each information search means, specified in the configuration information stored in the configuration storage unit, to execute an information search, when a search request is received.

### Advantageous Effects of Invention

According to the present invention, since a combination of information search means can be switched to another, different search functions can be implemented in response to a user situation or every request from a user. Further, since multiple hybrid search modes can be operated concurrently in parallel in one system, an appropriate hybrid search system can be easily constructed.

In addition, if selection information or collection information is included in the configuration information, the selection of information search means or the method of collecting search results can be switched and used.

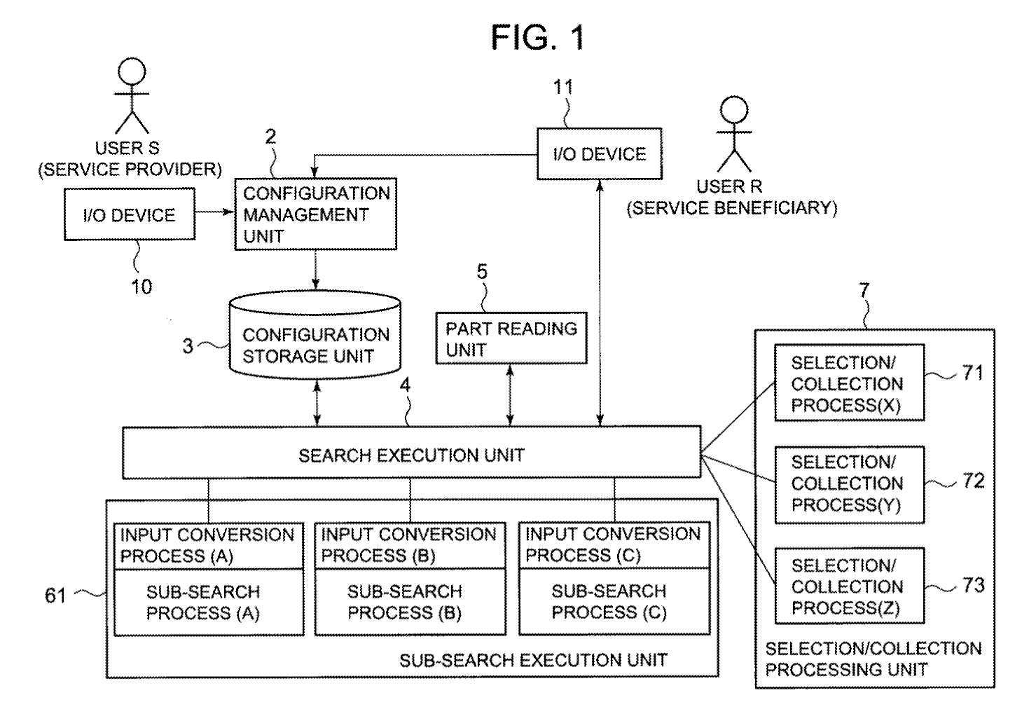

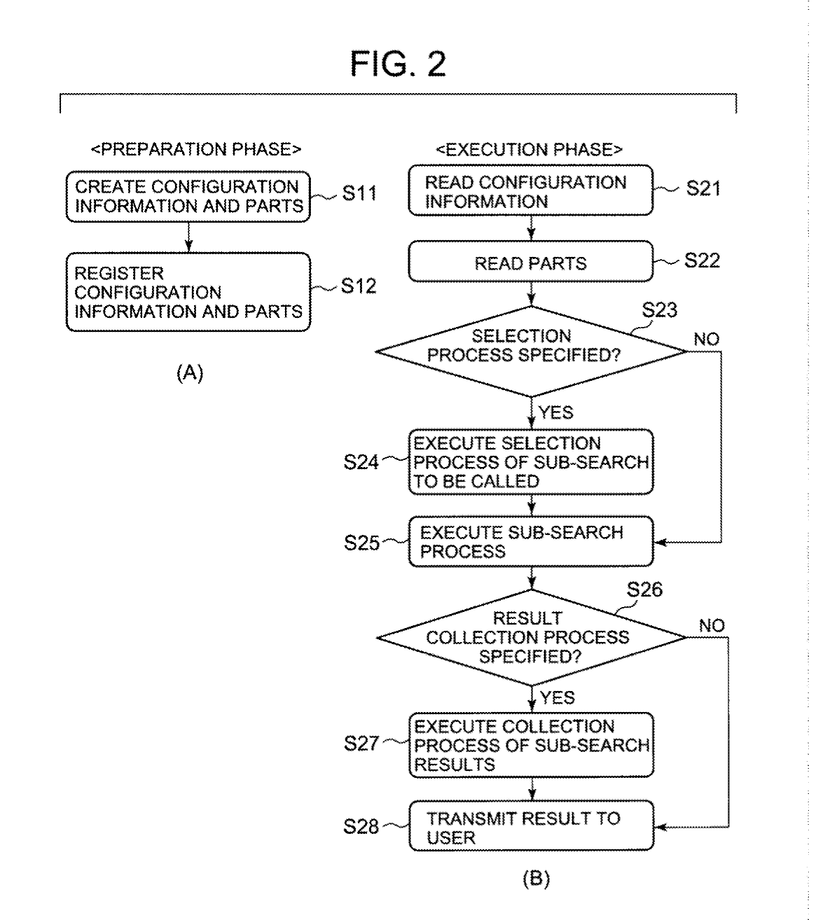

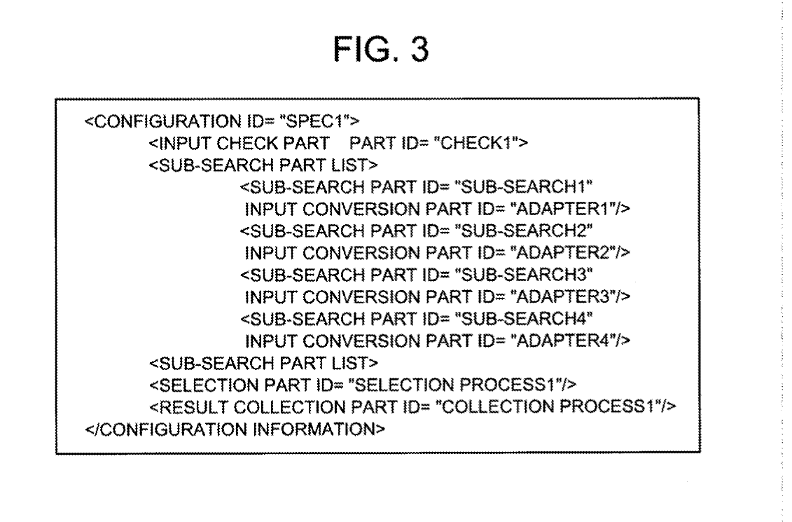

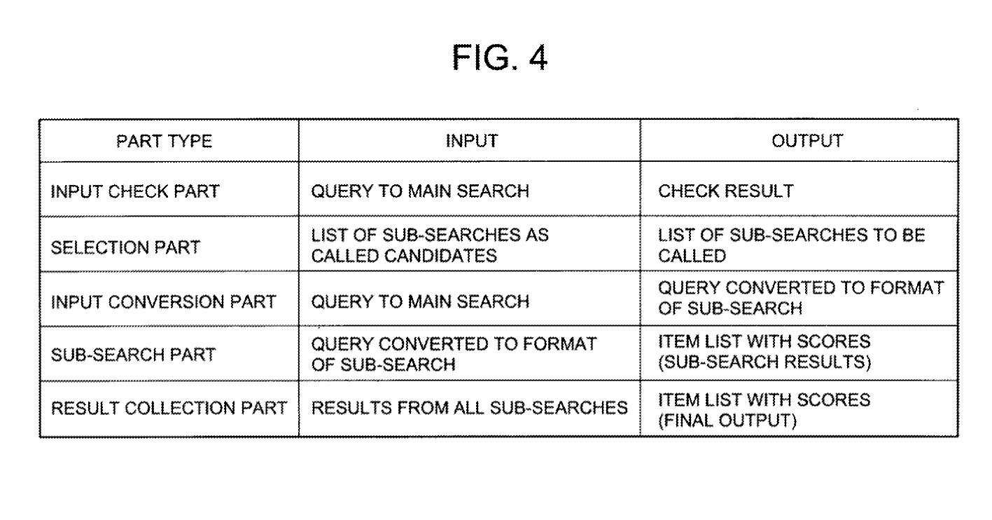

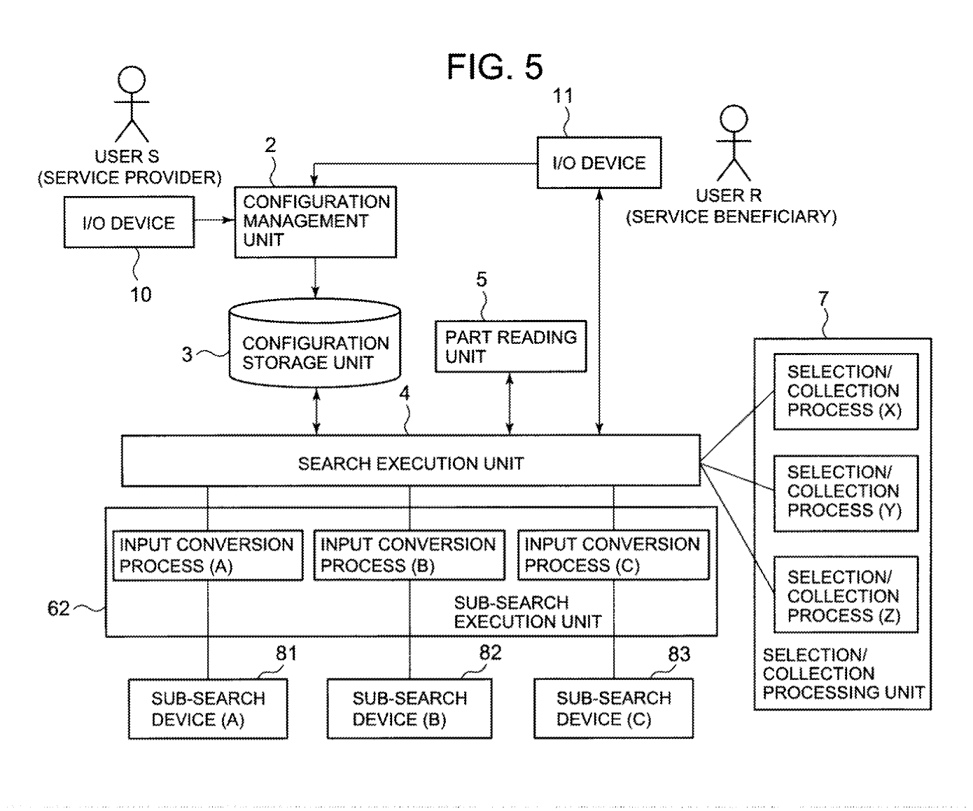

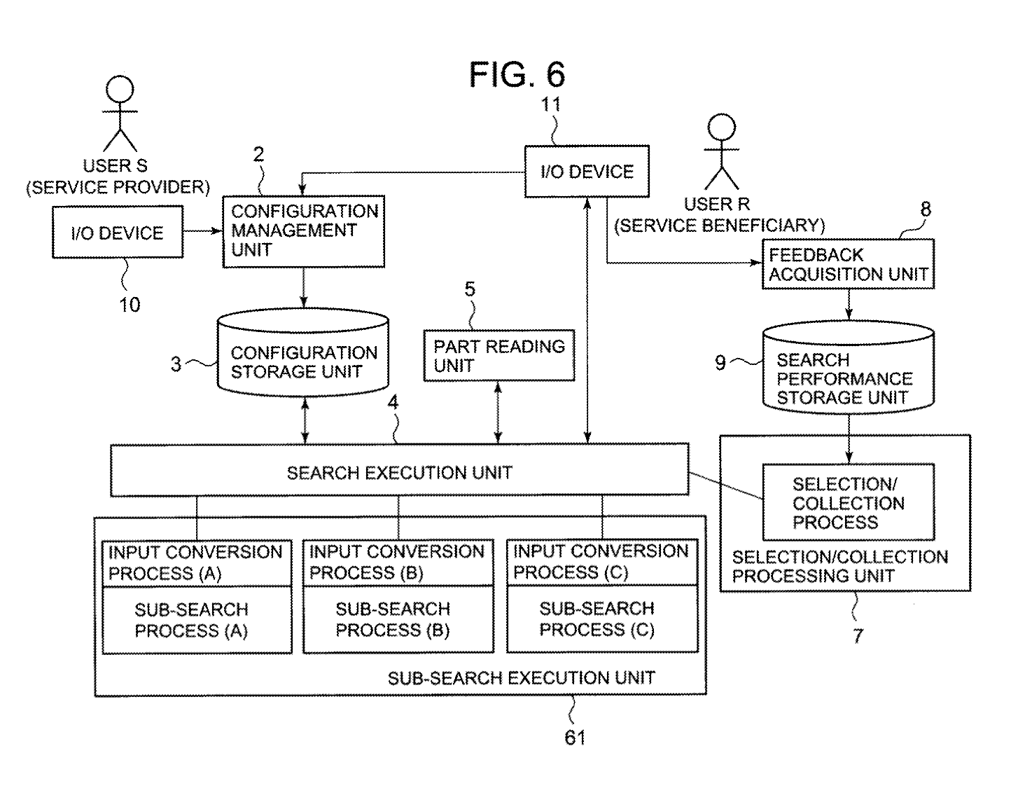

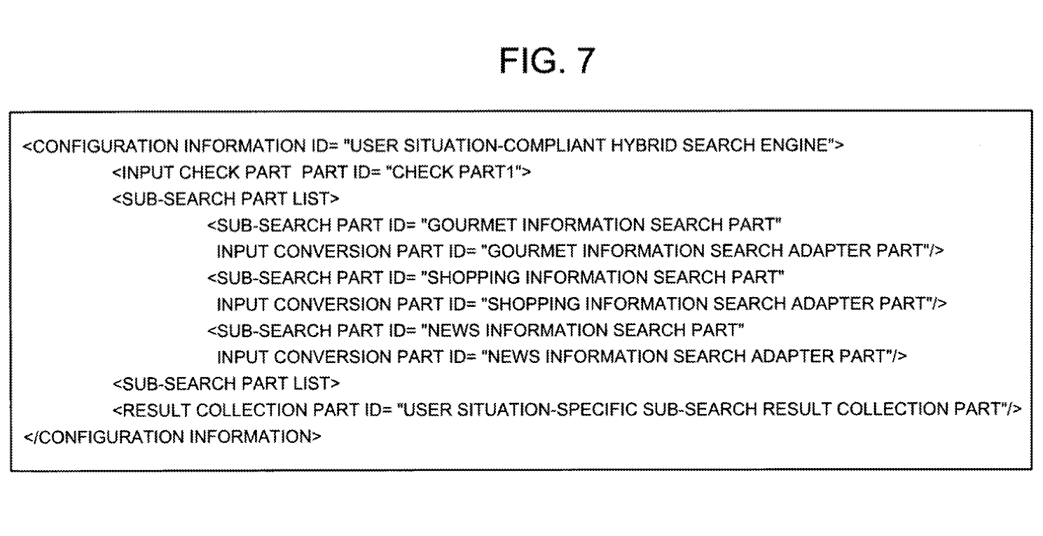

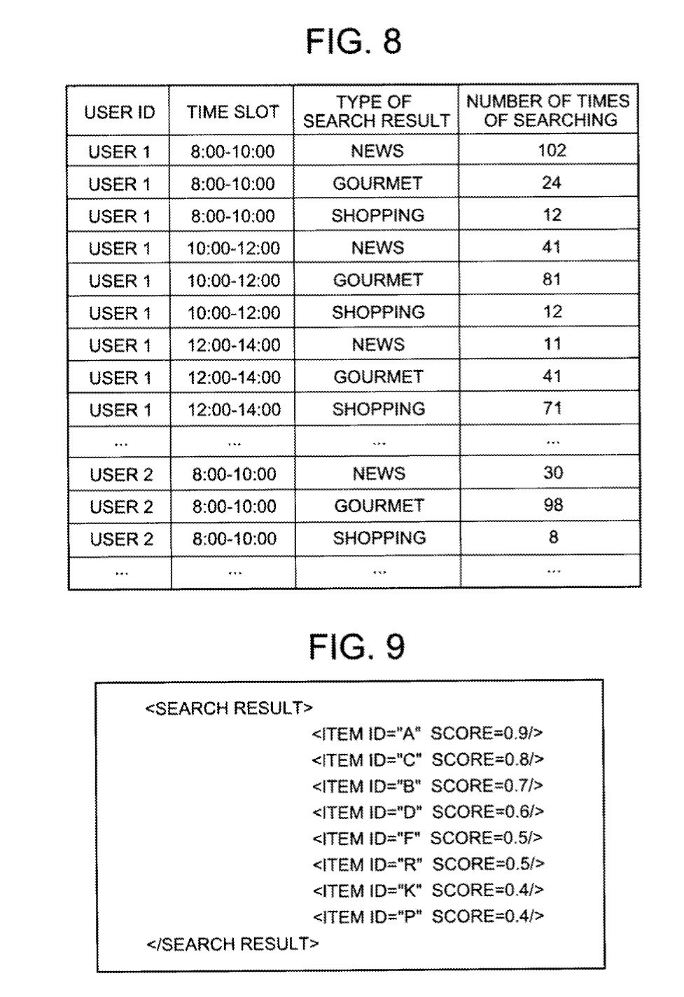

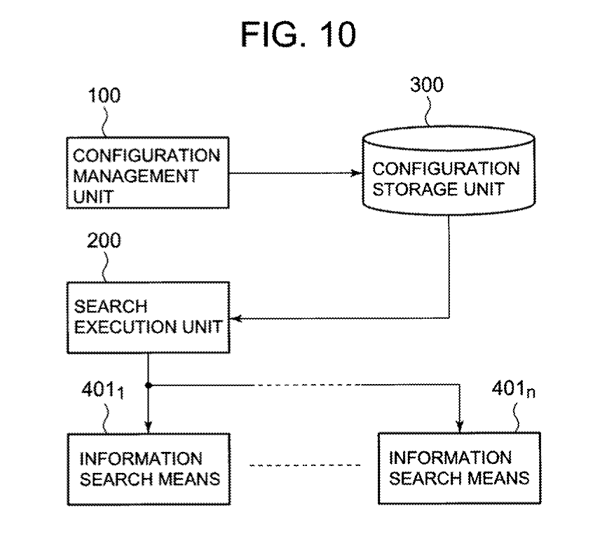

### BRIEF DESCRIPTION OF DRAWINGS

[FIG. 1] It depicts a block diagram showing a first exemplary embodiment of a hybrid search system according to the present invention.

[FIG. 2] It depicts a flowchart showing the operation of the hybrid search system.

[FIG. 3] It depicts an explanatory drawing showing an example of configuration information.

[FIG. 4] It depicts an explanatory drawing showing an example of the I/O formats of parts used upon execution of search processes.

[FIG. 5] It depicts a block diagram showing a second exemplary embodiment of a hybrid search system according to the present invention.

[FIG. 6] It depicts a block diagram showing a third exemplary embodiment of a hybrid search system according to the present invention.

[FIG. 7] It depicts an explanatory drawing showing an example of configuration information.

[FIG. 8] It depicts an explanatory drawing showing an example of search performance information.

[FIG. 9] It depicts an explanatory drawing showing an example of an item list with scores.

[FIG. 10] It depicts a block diagram showing the main parts of a hybrid search system according to the present invention.

### DESCRIPTION OF EMBODIMENT

Embodiments of the present invention will now be described with reference to the accompanying drawings.

### First Embodiment

FIG. 1 is a block diagram showing a configuration of a first exemplary embodiment of a hybrid search system according to the present invention. The hybrid search system shown in FIG. 1 includes an I/O device 10 such as a personal computer (PC) used by user S (service provider), a configuration management unit 2 receiving data from an I/O device 11 such as a PC used by user R (service beneficiary) through a communication network, a configuration storage unit 3, a search execution unit 4 capable of communicating with the I/O device 11 through a communication network, a part reading unit 5, a sub-search execution unit 61, and a selection/collection processing unit 7.

For example, user S is an operator of the hybrid search system and user R is a user who makes a search request to the hybrid search system. In FIG. 1, although one I/O device 11 used by one user R is shown, since many service beneficiaries can exist, many I/O devices used by the service beneficiaries can exist.

The configuration management unit 2, the search execution unit 4, the part reading unit 5, the sub-search execution unit 61, and the selection/collection processing unit 7 can be implemented by a computer executing processes according to a program. The configuration storage unit 3 can be implemented by a storage device incorporated in the computer or a storage device placed outside the computer.

When receiving, from the I/O device 10, configuration information indicative of a combination of information search means (search engines) and parts (program and the like) necessary to execute search processes, the configuration management unit 2 stores the configuration information and the parts in the configuration storage unit 3. The following may call each combination of search engines “hybrid search mode.” Thus, each hybrid search mode is a combination of multiple search engines.

When receiving a search process execution request (search request) from the I/O device 11 of user R, the search execution unit 4 requests the part reading unit 5 to read parts required to execute the requested search processes. The part reading unit 5 reads the necessary parts in response to the request. The search execution unit 4 causes the sub-search execution unit 61 to execute parts to be executed by the sub-search execution unit 61 among the parts read by the part reading unit 5.

The sub-search execution unit 61 executes sub-search parts such as search process programs. FIG. 1 illustrates that the sub-search execution unit 61 executes a plurality of input conversion process (A), input conversion process (B), and input conversion process (C), and a plurality of sub-search process (A), sub-search process (B), and sub-search process (C). The input conversion process (A) is paired with the sub-search process (A). The input conversion process (B) is paired with the sub-search process (B). The input conversion process (C) is paired with the sub-search process (C). Here, “being paired” means a one-to-one correspondence between both.

Although the “sub-search process” is a specific search process, it is managed by a unit for implementing the function of receiving a search request from user R (i.e., the function of “main search process”) and hence expressed as “sub-search process.” Further, in the first exemplary embodiment, a unit for implementing the function of “main search process” corresponds to the search execution unit 4.

The input conversion process (A) is accomplished by executing a corresponding sub-search part. The input conversion process (B) is accomplished by executing a corresponding. The input conversion process (C) is accomplished by executing a corresponding sub-search part.

FIG. 1 illustrates the input conversion process (A), the input conversion process (B), and the input conversion process (C), and the sub-search process (A), the sub-search process (B), and the sub-search process (C), but the sub-search execution unit 61 does not always execute these parts. Practically, the sub-search execution unit 61 executes input conversion processes and sub-search processes specified by information included in the configuration information.

The search process parts such as search process programs are executed to implement the above-mentioned search engines. The input conversion process (A), the input conversion process (B), and the input conversion process (C) implement search engines the characteristics of which are different from each other.

The selection/collection processing unit 7 performs processing for selecting sub-search parts to execute sub-search processes and processing for collecting the search results of the sub-search processes based on the selected sub-search parts.

Referring next to FIG. 2 to FIG. 4, the operation of the hybrid search system of the first exemplary embodiment will be described. FIG. 2 is a flowchart showing the operation of the hybrid search system. FIG. 3 is an explanatory drawing showing an example of configuration information. FIG. 4 is an explanatory drawing showing an example of the I/O formats (hereinafter called “I/O interface specifications) of parts used to execute search processes.

The hybrid search system executes processes of two-phases: configuration preparation phase and execution phase. The configuration preparation phase is a phase run before user R makes a search request. The execution phase is a phase to execute search processes according to the search request from user R.

First, the operation of the hybrid search system in the configuration preparation phase will be described. User S creates configuration information on the I/O device 10 to implement each hybrid search mode, and creates each part described in the configuration information to conform to the interface specifications shown in FIG. 4 (step S11).

FIG. 3 shows an example of configuration information having configuration information ID “SPEC1.” The configuration information with the configuration information ID “SPEC1” includes information to specify an input check part having part ID “check 1.”

The configuration information “SPEC1” also includes information specifying sub-search parts having sub-search part IDs “sub-search 1” to “sub-search 4,” and input conversion parts having input conversion part IDs “input conversion part 1” to “input conversion part 4.” Each of the input conversion parts having the input conversion part IDs “input conversion part 1” to “input conversion part 4” corresponds to each of the sub-search parts having the sub-search part IDs “sub-search 1” to “sub-search 4,” respectively. In other words, an input conversion part having an input conversion part ID “input conversion part n” (n=any one of 1 to 4) is paired with a sub-search part having a sub-search part ID “sub-search n.”

Further, the configuration information with the configuration information ID “SPEC1” includes information specifying a selection part having a selection part ID “selection process 1.” In addition, the configuration information with the configuration information ID “SPEC1” includes information specifying a result collection part having a result collection process ID “collection process 1.”

In the example shown in FIG. 3, the hybrid search mode specified by the configuration information ID “SPEC1” is a mode using the input check part specified by the part ID “check 1” among multiple input check parts, the sub-search parts each specified by a sub-search part ID “sub-search n” (where n is any one of 1 to 4) among the multiple sub-search parts, a selection part specified by the selection part ID “selection process 1” among the multiple selection parts, and the result collection part specified by the result collection process ID “collection process 1” among the multiple result collection parts.

The selection part corresponds to the rules of selecting the sub-search parts. For example, the selection part includes the rules of selecting a specific one or more sub-search parts from the multiple sub-search parts specified in the configuration information. Taking the configuration information illustrated in FIG. 3 as an example, the sub-search part specified by the sub-search part ID “sub-search n”(where n is any one of 1 to 4) is defined, but when the selection part includes the rules of selecting a sub-search part specified by a sub-search part ID “sub-search m” (where m is any one of 1 to 3), only a sub-search part specified by a sub-search part ID “sub-search m” (where m is any one of 1 to 3) is called as the sub-search part to actually execute a search process.

The result collection part corresponds to the rules of collecting the search results of respective sub-search processes based on the multiple sub-search parts. For example, the result collection part includes the rules of excluding the collection result of a specific sub-search process among the multiple sub-search processes or giving higher priority to the collection result of a specific sub-search process.

In the hybrid search system shown in FIG. 1, the selection/collection processing unit 7 executes the selection part and the result collection part, but FIG. 1 shows an example in which the selection/collection processing unit 7 executes selection/collection process (X), selection/collection process (Y), and selection/collection process (Z). The selection part in the selection/collection process (X), the selection part in the selection/collection process (Y), and the selection part in the selection/collection process (Z) are different from each other. The result collection part in the selection/collection process (X), the result collection part in the selection/collection process (Y), and the result collection part in the selection/collection process (Z) are also different from each other.

In the first exemplary embodiment, it is shown that a selection part and a result collection part are handled in one selection/collection process, i.e., an example is shown in FIG. 1 in which the selection process and the result collection process are correlated (they may be substantially the same). In other words, a case is taken as an example in which the search result based on the sub-search part excluded from the selection is excluded from the targets of the collection process.

However, the selection process to handle the selection part and the result collection process to handle the result collection part may be independent without association.

User S transmits, from the I/O device 10, multiple pieces of configuration information and parts configured as illustrated in FIG. 3, respectively, to the configuration management unit 2 (step S12). Of course, the content of configuration information other than the configuration information on the hybrid search mode specified by the configuration information ID “SPEC1” is different from the content illustrated in FIG. 3.

When the parts themselves already exist in the hybrid search system, or when the hybrid search system can easily collect the parts, user S may transmit information for specifying the parts, rather than transmitting the parts themselves to the configuration management unit 2.

The configuration management unit 2 stores each piece of the configuration information and parts received from the I/O device 10 in the configuration storage unit 3. Each piece of configuration information and parts are stored in the configuration storage unit 3, and this means that the configuration information and parts to implement each hybrid search mode have been registered with the hybrid search system.

Next, the operation of the hybrid search system in the execution phase will be described.

User R transmits a search request to the search execution unit 4 through the I/O device 11. The search request includes the specification of configuration information used (e.g., configuration information ID), and in addition thereto, any other information may be included.

The search execution unit 4 reads the configuration information specified by the user R from the configuration storage unit 3 (step S21). Then, the search execution unit 4 requests the part reading unit 5 to read, for example, from the configuration storage unit 3, the parts included in the configuration information, i.e., the input check part specified by the input check part ID, the sub-search parts specified by the sub-search part IDs, the input conversion parts specified by the input conversion part IDs, the selection part specified by the selection parts ID, and the collection part specified by the result collection process ID. The part reading unit 5 reads the parts in response to the request (step S22). Then, the read parts are output to the search execution unit 4. The search execution unit 4 executes the input check part read by the part reading unit 5 and indicated by the input check part ID to check whether input information can be created for the sub-search parts indicated by all the sub-search part IDs included in the configuration information. If it is determined that input information can be created for all the sub-search parts, processing step S23 and steps that follow are executed.

In step S23, when no selection part ID is included in the configuration information (when the selection process is not executed), the search execution unit 4 outputs, to the sub-search execution unit 61, the input conversion parts and the sub-search parts read by the part reading unit 5, and causes the sub-search execution unit 61 to execute the input conversion parts and the sub-search parts (step S25).

For example, when the input conversion parts read by the part reading unit 5 are input conversion parts for executing the input conversion process (A), the input conversion process (B), and the input conversion process (C), the sub-search execution unit 61 executes the input conversion process (A), input conversion process (B), and the input conversion process (C) as illustrated in FIG. 1. Further, when the sub-search parts read by the part reading unit 5 are sub-search parts for executing the sub-search process (B), and the sub-search process (C), the sub-search execution unit 61 executes the sub-search process (B) and the sub-search process (C) as illustrated in FIG. 1.

When a selection part ID is included in the configuration information (when the selection process is executed) (step 23), the search execution unit 4 outputs, to the selection/collection processing unit 7, the selection part read by the part reading unit 5. The selection/collection processing unit 7 selects a sub-search part defined in the selection part from among the multiple sub-search parts defined in the configuration information (step S24). Then, the selection result is output to the search execution unit 4. The search execution unit 4 causes the sub-search execution unit 61 to execute the sub-search part selected by the selection/collection processing unit 7 and a corresponding input conversion part (step S25).

The sub-search part executed by the sub-search execution unit 61 is a program or the like to execute a search process based on a keyword, for example, and the input conversion part is a part to execute a process to information included in the search request entered by user R into information processable by the corresponding sub-search part with reference to the I/O interface specifications illustrated in FIG. 4. In the example shown in FIG. 4, the input format to the input conversion part is a “query to a main search” and the output format is a “query converted to the format of sub-search.” Therefore, for example, the input conversion part (A) performs processing for converting, into a format capable of being handled by the sub-search part (A), the format of a query entered by user R into the search execution unit 4 to implement the function of the main search process.

The existence of the input conversion part enables user R to issue a search request to the hybrid search system in a single interface format, regardless of the format of the input interface of the sub-search part to execute the search process in actuality.

Further, when no result collection part ID is included in the configuration information (i.e., when no result collection process is executed) (step 26), the search execution unit 4 transmits, to the I/O device 11, the search results of the sub-search execution unit 61 as is (step S28).

When a result collection part ID is included in the configuration information (i.e., when the result collection process is executed) (step 26), the search execution unit 4 outputs the result collection part read by the part reading unit 5 to the selection/collection processing unit 7, and the search results of the sub-search execution unit 61 to the selection/collection processing unit 7. The selection/collection processing unit 7 collects the search results of the sub-search execution unit 61 according to the rules included in the result collection part (step S27), and outputs the collection result to the search execution unit 4. The search execution unit 4 transmits, to the I/O device 11, the collection result as the search results (step S28).

The result collection process executed by the selection/collection processing unit 7 is a process to extract a search result commonly output by more sub-search processes among the search results and further select some upper-level search results among the extracted search results (for example, which means that many sub-search processes output the results). In other words, the rule of indicating such a process is included in the result collection part.

In the exemplary embodiment, user R transmits, to the search execution unit 4, the search request including the specification of the configuration information used, i.e., the configuration information used by user R is specified. It is preferred that the hybrid search system should provide, to the I/O device 11, a list of search fields (categories), the search purposes, and configuration information corresponding to the field to let user R decide which configuration information should be used.

Further, user R may be caused to specify the search field or the search purpose rather than specifying configuration information used. For example, when user R is caused to specify the search field or the search purpose, the search execution unit 4 may decide on configuration information matching the search field or the search purpose specified by user R from the List of the search fields, the search purposes, and the configuration information.

Further, in the exemplary embodiment, the selection part is configured to include the rules of selecting a sub-search part for executing a search process in actuality at the start of the search process, but the selection part may also be configured to include the rule of changing the way to combine the sub-search parts during execution of the search process. For example, the selection part may also include the rule of interrupting the operation of a specific sub-search processing unit in multiple sub-search processing units for executing search processes when a predetermined condition is satisfied during execution of the search process.

Further, in the exemplary embodiment, the result collection part is configured to include the rules upon collection of search results of multiple sub-search processes, but it may further include the rules of collecting information on the behavior of user R and excluding the collection result of specific sub-search processes or giving higher priority to the collection result of a specific sub-search process based on the collected information.

As described above, in the first exemplary embodiment, since particular processes (respective sub-search processes) in the hybrid search method are separated from each other, and configuration information indicative of a combination of sub-search processes is managed, different hybrid search modes to be used can be switched according to the request from the user.

Further, in the first exemplary embodiment, since multiple pieces of configuration information indicative of respective hybrid search modes can be stored in the configuration storage unit 3 at the same time, the multiple hybrid search modes can be equipped in one hybrid search system.

### Second Embodiment

FIG. 5 is a block diagram showing a configuration of a second exemplary embodiment of a hybrid search system according to the present invention. The hybrid search system shown in FIG. 5 includes, instead of the sub-search execution unit 61 in the first exemplary embodiment shown in FIG. 1, a sub-search execution unit 62, a sub-search device (A) 81, a sub-search device (B) 82, and a sub-search device (C) 83.

In the first exemplary embodiment, the sub-search execution unit 61 executes the input conversion process (A), the input conversion process (B), and the input conversion process (C), and the sub-search process (A), the sub-search process (B), and the sub-search process (C), but the sub-search execution unit 62 executes only the input conversion process (A), the input conversion process (B), and the input conversion process (C).

The sub-search device (A) 81, the sub-search device (B) 82, and the sub-search device (C) 83 are provided outside the sub-search execution unit 62. For example, when the configuration management unit 2, the search execution unit 4, the part reading unit 5, and the selection/collection processing unit 7 are implemented by a server, the sub-search device (A) 81, the sub-search device (B) 82, and the sub-search device (C) 83 are search engines available from the server through a communication network such as the Internet.

The operation of the hybrid search system of the second exemplary embodiment is the same as the operation of the hybrid search system of the first exemplary embodiment except that the sub-search execution unit 62 itself does not execute search processes and causes the external sub-search device (A) 81, sub-search device (B) 82, and sub-search device (C) 83 to execute the search processes.

In the second exemplary embodiment, since the sub-search execution unit 62 does not execute the search processes, the configuration of the sub-search execution unit 62 can be simplified. Further, since existing search engines exist outside the server or the like, the time and cost required to construct the hybrid search system can be reduced.

### Third Embodiment

FIG. 6 is a block diagram showing a configuration of a third exemplary embodiment of a hybrid search system according to the present invention. The hybrid search system shown in FIG. 6 includes a feedback acquisition unit 8 and a search performance storage unit 9 in addition to the configuration management unit 2, the configuration storage unit 3, the search execution unit 4, the part reading unit 5, the sub-search execution unit 61, and the selection/collection processing unit 7 shown in FIG. 1. Unlike in FIG. 1, only one selection/collection process in the selection/collection processing unit 7 is shown in FIG. 6, but the function of the selection/collection processing unit 7 is the same as that in the first exemplary embodiment.

The feedback acquisition unit 8 collects information, particularly information on search results, input by the I/O device 11 from the search execution unit 4. Then, the collected information is stored in the search performance storage unit 9 on a user-by-user basis.

The configuration management unit 2, the search execution unit 4, the part reading unit 5, the sub-search execution unit 61, the selection/collection processing unit 7, and the feedback acquisition unit 8 can be implemented by a computer executing processes according to a program. The configuration storage unit 3 and the search performance storage unit 9 can be implemented by a storage device incorporated in the computer or a storage device placed outside the computer.

The following takes a case as an example in which the hybrid search system executes a gourmet information search process, a shopping information search process, a news information search process as sub-searches. Further, a case is taken as an example in which these search processes are selected automatically and appropriately on a user-by-user basis or per time slot.

Referring next to FIG. 7 to FIG. 9, the operation of the hybrid search system of the third exemplary embodiment will be described. FIG. 7 is an explanatory drawing showing an example of configuration information. FIG. 8 is an explanatory drawing showing search performance information stored in the search performance storage unit 9. FIG. 9 is an explanatory drawing showing an example of an item list with scores as search results.

The feedback acquisition unit 8 stores search results in the search performance storage unit 9 as search performance information each time user R or another service beneficiary receives the search results at the I/O device 11 or another device. As shown in FIG. 8, the search performance information stored in the search performance storage unit 9 includes the time slot in which the search results were received, the types of search results, and information in which the number of times (recommended number of times) of searching is associated with information (user ID) specifying the user that received the search request. The feedback acquisition unit 8 may also input search results from the search execution unit 4.

Like in the first exemplary embodiment, user S creates configuration information in the configuration preparation phase on the I/O device 10 to implement each hybrid search mode.

In the third exemplary embodiment, a case is taken as an example in which user S creates configuration information illustrated in FIG. 7. Shown in FIG. 7 is an example of configuration information having a configuration information ID “user situation-compliant hybrid search engine.” The configuration information whose configuration information ID is “user situation-compliant hybrid search engine” includes information specifying an input check part having a part ID “check part 1.”

The configuration information on “user situation-compliant hybrid search engine” also includes information for specifying sub-search parts having sub-search part IDs “gourmet information search part,” “shopping information search part,” and “news information search part,” and information for specifying input conversion parts having input conversion part IDs “gourmet information search adapter part,” “shopping information search adapter part,” and “news information search adapter part.”

The configuration information having the configuration information ID “user situation-compliant hybrid search engine” further includes information specifying a result collection part having a result collection process ID “user situation-compliant search result collection part.”

Each part described in the configuration information is created to conform to the I/O interface specifications shown in FIG. 4. In the third exemplary embodiment, the input check part with the part ID “check part 1” is created. The input check part is a part to check whether input information can be created for the sub-search parts indicated by all the sub-search part IDs included in the configuration information.

A gourmet information search part for performing a gourmet information search, a shopping information search part for performing a shopping information search, and a news information search part for performing a news information search are also created as sub-search parts. Further, a gourmet information search adapter part, a shopping information search adapter part, and a news information search adapter part are created as input conversion parts corresponding to the sub-search parts, respectively, to convert the search request from the user into an appropriate format (the sub-search parts can handle).

Further, a user situation-specific sub-search result collection part is created as a result collection part. The user situation-specific sub-search result collection part is a part executing a process to collect the search results of the respective sub-search processes according to the user and the user situation.

Specifically, the user situation-specific sub-search result collection part is a part for determining the type of information to be provided on a user-by-user basis or per time slot based on search performance information (see FIG. 8) accumulated in the search performance storage unit 9 through the feedback acquisition unit 8 shown in FIG. 6. Taking, as an example, the search performance information shown in FIG. 8, it is a part for executing such a process to select more news in a time slot 8:00-10:00 because the number of times news is selected for user R1 in the time slot is higher than the number of times the other information is selected.

In the execution phase, user R transmits a search request to the search execution unit 4 through the I/O device 11. The search request includes the user ID of user R as well as the specification of configuration information used.

The search execution unit 4 reads the configuration information specified by user R from the configuration storage unit 3. Then, the search execution unit 4 requests the part reading unit 5 to read, for example, from the configuration storage unit 3, the input check part specified by the input check part ID, the sub-search parts specified by the sub-search part IDs, the input conversion parts specified by the input conversion part IDs, and the result collection part specified by the result collection process ID included in the configuration information. In response to the request, the part reading unit 5 reads these parts. Then, the read parts are output to the search execution unit 4.

The search execution unit 4 executes the input check part indicated by the input check part ID included in the configuration information specified in the search request to check whether input information can be created for the sub-search parts indicated by all the sub-search part IDs included in the configuration information.

If it is determined that input information can be created for all the sub-search parts, the search execution unit 4 outputs, to the search execution unit 4, the input conversion parts and the sub-search parts read by the part reading unit 5. The search execution unit 4 causes the sub-search execution unit 61 to execute the input conversion parts and the sub-search parts.

For example, in the example shown in FIG. 6 and FIG. 7, the sub-search execution unit 61 executes the gourmet information search process as the sub-search process (A), the shopping information search process as the sub-search process (B), and the news information search process as the sub-search process (C).

Since the result collection part ID is included in the configuration information, the search execution unit 4 outputs the result collection part read by the part reading unit 5 to the selection/collection processing unit 7. The search results of the sub-search execution unit 61 are also output to the selection/collection processing unit 7. The selection/collection processing unit 7 collects the search results of the sub-search execution unit 61 according to the rules included in the result collection part, and outputs the collection result to the search execution unit 4. The search execution unit 4 transmits the collection result to the I/O device 11 as the search results.

In this example, the result collection process is a user situation-specific sub-search result collection process based on the user situation-specific sub-search result collection part. In other words, the selection/collection processing unit 7 determines the type of information to be provided on a user-by-user basis or per time slot based on the search performance information accumulated in the search performance storage unit 9. Taking, as an example, the search performance information shown in FIG. 8, it is a part for executing such a process to select more news in a time slot 8:00-10:00 when the time at which the search request is issued from user R1 or the search results on user R1 are obtained is in the time slot 8:00-10:00 because the number of times news is selected for user R1 in the time slot is higher than the number of times the other information is selected.

Note that “select more news” means that among the search results of the gourmet information search process, the shopping information search process, and the news information search process, more search results of the news information search process are selected than the search results of the gourmet information search process and the search results of the shopping information search process.

In the third exemplary embodiment, the selection/collection processing unit 7 executes the process to collect the search results of the respective sub-search processes according to the user and the user situation, and this can increase the possibility of providing the user with search results more relevant to the user.

Here, the search performance per time slot is taken as an example of the user situation, but the user situation handled by the selection/collection processing unit 7 is not limited to the search performance per time slot. For example, information indicative of the environment in which the user exists at present (e.g., existence position information) may be so collected that more search results of the type that matches the environment in which the user exists are selected, or that a higher score is given to search results of the type that matches the environment in which the user exists to select a predetermined number of search results in order from the highest score.

FIG. 9 is an explanatory drawing showing an example of an item list with scores. The selection/collection processing unit 7 gives a higher score to search results of the type that matches the environment in which the user exists, and puts the search results (each search result is not always one) of all the search processes (in this example, the gourmet information search process, the shopping information search process, and the news information search process) in descending order according to score as shown in FIG. 9. Then, for example, five search results with higher scores are selected and output to the search execution unit 4.

As illustrated in FIG. 4, the output format of output data from sub-search parts is the item list with scores in the I/O interface specifications. Thus, in this exemplary embodiment, the search results of all the search processes (in this example, the gourmet information search process, the shopping information search process, and news information search process) output to the search execution unit 4 as respective item lists with scores, and output from the search execution unit 4 to the selection/collection processing unit 7.

Further, as illustrated in FIG. 4, the output format of output data from the result collection part is the item list with scores in the I/O interface specifications. Thus, in this exemplary embodiment, the item list with scores is output from the selection/collection processing unit 7 as the final search results. Then, the search execution unit 4 outputs the item list with scores as the final search results.

As illustrated in FIG. 4, the input format of input into the selection part is a “list of sub-searches as called candidates” in the I/O interface specifications. Further, the output format of output from the selection part is a “list of sub-searches as called candidates.” Thus, for example, when the selection part is configured to select sub-search parts that satisfy predetermined conditions, if input information with data indicative of multiple sub-search parts listed is given to the selection part, the selection/collection processing unit 7 that executes the selection processes based on the selection part can output, as the selection results, output information with data indicative of the selected sub-search parts listed.

FIG. 10 is a block diagram showing the main parts of the hybrid search system according to the present invention. As shown in FIG. 1, the hybrid search system includes configuration management unit 100 (corresponding to the configuration management unit 2 in FIG. 1 or the like) for storing configuration information specifying a plurality of information search means in a configuration storage unit 300 (corresponding to the configuration storage unit 3 in FIG. 1 or the like), respective information search means 401₁ to 401ₙ (corresponding to the parts for executing the sub-search process (A), the sub-search process (B), and the sub-search process (C) in the sub-search execution unit 61 or 62, or corresponding to the sub-search device (A) 81, sub-search device (B) 82, and sub-search device (C) 83 shown in FIG. 1 or the like) specified by configuration information stored in the configuration storage unit 300 according to a search request, and a search execution unit 200 for executing information searches.

The configuration information may include selection information for selecting the information search means 401₁ to 401ₙ, and a selection processing unit (corresponding to the selection/collection processing unit 7 shown in FIG. 1 or the like) may be provided to select information search means for executing an information search according to the selection information.

Further, the configuration information may collection information specifying a process mode for collecting search results from the information search means, and a collection processing unit (corresponding to the selection/collection processing unit 7 shown in FIG. 1 or the like) may be provided to collect the search results from the information search means 401₁ to 401ₙ that executed information searches according to the collection information.

Further, the configuration information may include input conversion part information indicative of input conversion parts, and input conversion means (corresponding to parts for executing the input conversion process (A), the input conversion process (B), and the input conversion process (C) in the sub-search execution unit 61 or 62 shown in FIG. 1 or the like) may be provided to convert the format of the search request into a format in which each part can provide input to execute an information search according to the input conversion part information.

While the present invention has been described with reference to the exemplary embodiments and examples, the present invention is not intended to be limited to the aforementioned exemplary embodiments and examples. Various changes understandable to those skilled in the art can be made in the configurations and details of the present invention within the scope of the present invention.

This application claims priority based upon Japanese Patent Application No. 2008-294919 filed Nov. 18, 2008, which is incorporated by reference herein in its entirety.

### INDUSTRIAL APPLICABILITY

The present invention can be applied to uses such as a meta-search service for searching across multiple Web search engines and an information recommend service for recommending information depending on the user situation or position.

### REFERENCE SIGNS LIST

2 Configuration Management Unit

3 Configuration Storage Unit

4 Search Execution Unit

5 Part Reading Unit

7 Selection/Collection Processing Unit

10 I/O Device

11 I/O Device

61, 62, 63 Sub-search Execution Unit

81 Sub-search Device (A)

82 Sub-search Device (B)

83 Sub-search Device (C)

100 Configuration Management Unit

200 Search Execution Unit

300 Configuration Storage Unit

401₁ to 401ₙ Information search means

1-13. (canceled)

14. A hybrid search system for combining a plurality of information search means to search for information, comprising:
a configuration management unit for storing configuration information used in order to specify the plurality of information search means in a configuration storage unit; and
a search execution unit for selecting a plurality of information search means by means of a selection means specified by the configuration information stored in the configuration storage unit, and causing selected information search means to execute an information search, in order to provide an information suitable for a taste or a situation of a user, when a search request is received.

15. The hybrid search system according to claim 14, wherein
the configuration information includes selection information for determining a selection process of the information search means, and
the system further comprising: a selection processing unit to select an information search means to be caused to execute an information search according to the selection information.

16. The hybrid search system according to claim 14, wherein
the configuration information includes collection information specifying a process to collect search results from the information search means, and
the system further comprising: a collection processing unit to collect, according to the collection information, the search results from the information search means that executed the information searches.

17. The hybrid search system according to claim 16, wherein the collection processing unit outputs the search results from the information search means as an item list with scores, based on a response history of a user.

18. The hybrid search system according to claim 14, wherein
the configuration information includes information for specifying parts to implement the information search means,
the configuration storage unit stores the parts to implement the information search means, and
the information search means execute information searches based on the parts specified in the configuration information and read from the configuration storage unit.

19. The hybrid search system according to claim 18, wherein
the configuration information includes input conversion part information indicative of input conversion parts, and
input conversion means is further comprised to convert a format of the search request into a format in which each part can provide input to execute an information search according to the input conversion part information.

20. The hybrid search system according to claim 18, further comprising
input means for transmitting the configuration information and the parts specified by the configuration information to the configuration management unit,
wherein the configuration management unit stores, in the configuration storage unit, the configuration information and the parts received from the input means.

21. The hybrid search system according to claim 14, further comprising a server equipped with the search execution unit and the information search means for executing the information searches.

22. The hybrid search system according to claim 14, further comprising
a server equipped with the search execution unit,
wherein the search execution unit causes information search means located outside the server to execute the information searches.

23. A hybrid search method for combining a plurality of information search means to search for information, comprising:
storing configuration information used in order to specify the plurality of information search means in a configuration storage unit
selecting a plurality of information search means by means of a selection means specified by the configuration information stored in the configuration storage unit, when a search request is received; and
causing selected information search means to execute an information search.

24. The hybrid search method according to claim 23, further comprising:
storing parts in the configuration storage unit to implement information searches, and
executing information searches based on the parts specified in the configuration information and read from the configuration storage unit.

25. A hybrid search program causing a computer in a hybrid search system, in which a plurality of information search means are combined to search for information, to execute:
a process to store configuration information used in order to specify the plurality of information search means in a configuration storage unit
a process to select a plurality of information search means by means of a selection means specified by the configuration information stored in the configuration storage unit, when a search request is received; and
a process to cause selected information search means, specified in the configuration information stored in the configuration storage unit, to execute an information search, when a search request is received.

26. The hybrid search program according to claim 25, causing the computer further to execute:
a process to store parts in the configuration storage unit to implement information searches; and
a process to execute the information searches based on the parts specified in the configuration information and read from the configuration storage unit.
